(19) United States
(12) Patent Application Publication
(10) Pub. No.: US 2017/0019199 A1
(43) Pub. Date: Jan. 19, 2017

(54) Audio Broadcast Recording Device

(71) Applicant: Neil Robert-John Matsch, Apple Valley, MN (US)

(72) Inventor: Neil Robert-John Matsch, Apple Valley, MN (US)

(21) Appl. No.: 15/213,372

(22) Filed: Jul. 18, 2016

Related U.S. Application Data
(60) Provisional application No. 62/193,996, filed on Jul. 17, 2015.

(51) Int. Cl. H04H 40/90; G06F 17/30; G06F 3/16

(52) U.S. Cl. CPC H04H 40/90; G06F 3/162; G06F 3/165; G06F 17/30769

(57) ABSTRACT

An audio broadcast recording device records live radio broadcasts. The device is similar in size and shape to a smartphone, with a large visual display occupying most of the front surface, and also provides a set of audio function buttons on its front surface which perform functions of recording, playing, fast forwarding, pausing, and rewinding, applied to radio broadcasts and podcasts. The device creates and stores digital audio files, accessible via a searchable and sortable database. Volume controls, a headphone jack, and two Universal Service Bus (USB) ports are provided on the side surface.

### CROSS-REFERENCE TO RELATED APPLICATIONS

This application claims the benefit of U.S. Provisional Application No. 62/217,056, filed Sep. 11, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to mobile electronic devices and in particular to an audio broadcast recording device. Individuals who are interested in live radio broadcasts or podcasts represent a variety of niche audiences. Some are interested in live music concerts. Others are interested in politics or religion, and prefer listening to a speech from a political candidate, or a sermon by a religious figure. Unfortunately, despite a wide range of mobile electronic devices which are tailored to suit specific purposes, the ability to record a radio broadcast or podcast has been overlooked. Audio broadcast enthusiasts would be interested in a device which can duplicate all of the functions of their cable television DVR devices at home. An audio broadcast recording device, which provides a full range of recording and playback functions for radio broadcasts and podcasts, would resolve this problem.

### SUMMARY OF THE INVENTION

Accordingly, the invention is directed to an audio broadcast recording device. The device is similar in size and shape to a smartphone, with a large visual display occupying most of the front surface, and also provides a set of audio function buttons on its front surface which perform functions of recording, playing, fast forwarding, pausing, and rewinding, applied to radio broadcasts and podcasts. The device creates and stores digital audio files, accessible via a searchable and sortable database. Volume controls, a headphone jack, and two Universal Service Bus (USB) ports are provided on the side surface.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front view of the first exemplary embodiment, displaying the device 10, the visual display 11, the audio control buttons 12, and the USB ports 15.

FIG. 2 is a side view of the first exemplary embodiment, displaying the device 10, the volume control buttons 13, the headphone jack 14, and the USB ports 15.

FIG. 3 is a rear view of the first exemplary embodiment, displaying the device 10, the stand 21, and the rear surface 22.

FIG. 4 is a side view of the first exemplary embodiment, displaying the device 10 and the stand 21 in an open position.

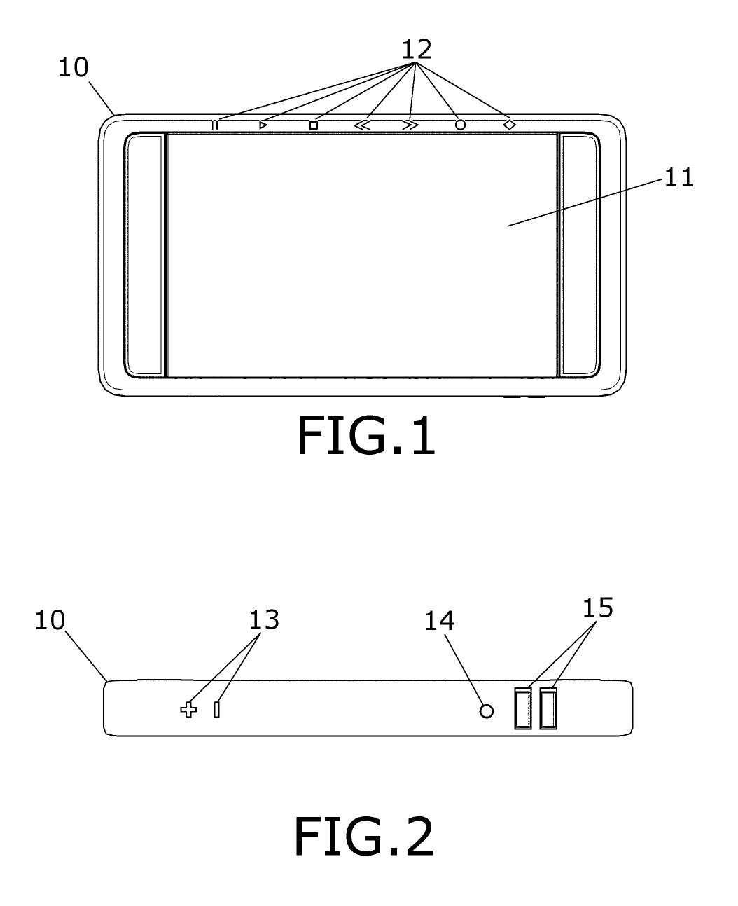

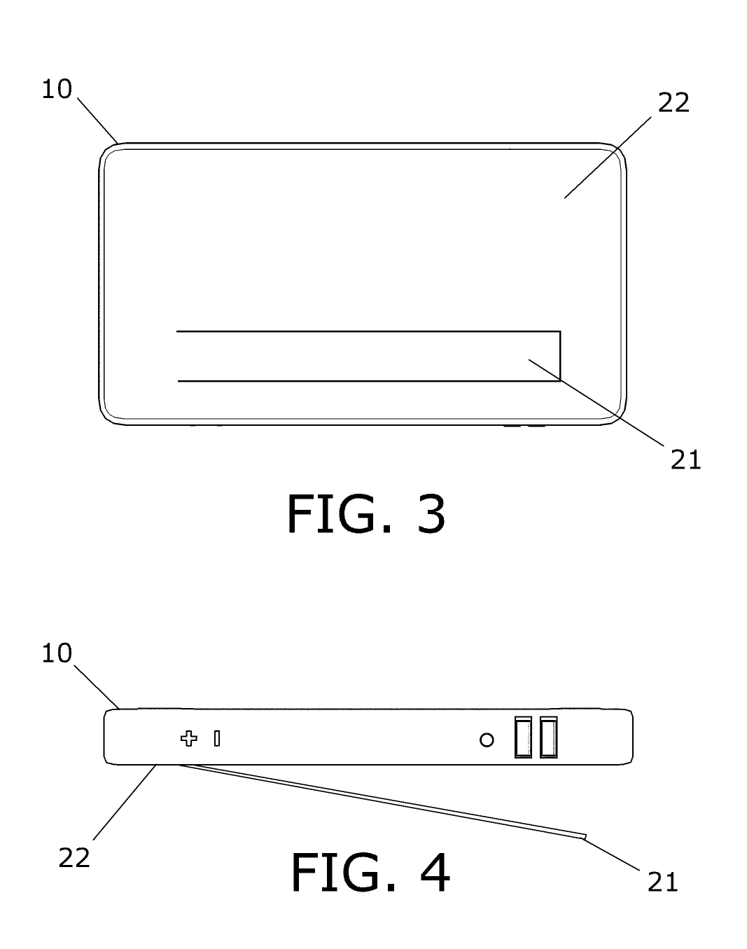

### DETAILED DESCRIPTION OF THE INVENTION

Referring now to the invention in more detail, the invention is directed to an audio broadcast recording device 10.

The first exemplary embodiment is comprised of a device 10 which is similar in size and shape to a smartphone, with a large visual display 11 occupying most of the front surface of the body 20. The device 10 also provides a set of audio function buttons 12 on its front surface which perform functions of recording, playing, fast forwarding, pausing, and rewinding, applied to radio broadcasts and podcasts. The audio function buttons 12 include a “live radio” button, which will play radio broadcasts from AM, FM, and satellite radio stations.

The device 10 creates and stores digital audio files, which are accessible via a searchable and sortable database. Volume control buttons 13, a headphone jack 14, and two Universal Service Bus (USB) ports 15 are provided on the side surface. Like a smartphone, the device 10 provides a means for creating and storing digital audio files through the use of an internal microprocessor and memory device and an internal battery which may be recharged via either of the USB ports 15. A detachable power cord, which may be plugged into one of the USB ports 15 and any three-pronged wall outlet for recharging, is provided.

The visual display 11 provides a touchscreen function. A mobile application is pre-loaded on the memory device and may be used to operate a user interface on the visual display 11. The user interface may be used to transfer digital audio files to and from other devices via the USB ports 15, search and sort a database of digital audio files stored on the device 10, and search the Internet for images and information related to the digital audio files, such as images of the performers or cover art from their albums. Such searched images and information may subsequently be displayed on the visual display 11 while a related digital audio file is being played.

The device 10 provides a folding stand 21 on its rear surface 22, such that it may be placed on a flat surface, such as a tabletop, in an upright position. The folding stand 21 collapsing within the rear surface 22 when in a stored position and extending outwardly from the rear surface 22 when in an open position. Optionally, the device 10 may also provide the customary components and functions of some other type of electronic device, such as a smartphone with cellular telephone and Internet functions and a camera.

To use the first exemplary embodiment, the user may listen to live audio broadcasts or digital audio files, performing the functions of recording, playing, fast forwarding, pausing, and rewinding, using audio function buttons 12 which are provided. The user may control the volume with the volume control buttons 13 which are provided, and may transfer digital audio files to and from other devices, and recharge the battery, using the USB ports 15 which are provided.

Electronic components of the device 10 preferably include a touchscreen visual display 11, audio control buttons 12, volume control buttons 13, a headphone jack 14, two USB ports 15, a microprocessor, a memory device, a receiver capable of receiving AM, FM, and satellite radio broadcasts and podcasts, an internal ring antenna, and a rechargeable battery.

The device 10 is preferably manufactured from rigid, durable materials, such as steel, brass, copper alloy, plastic, and aluminum alloy. The visual display 11 is preferably manufactured from a rigid, durable material which is transparent, such as plastic or malacrylate. The power cord is preferably manufactured from braided copper alloy wire sheathed in plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An audio broadcast recording device, comprising:
a. a body having a front surface, rear surface, and side surfaces;
b. a visual display occupying most of the front surface of the body;
c. a plurality of function buttons located on the front surface of the body;
d. means of creating and storing digital audio files;
e. a set of volume control buttons on one of said side surfaces;
f. a headphone jack on one of said side surfaces;
g. at least one universal service bus port on one of said side surfaces;
h. said audio broadcast recording device being configured to receive and play over the air radio broadcasts from AM, FM, or satellite radio stations;
i. said audio broadcast recording device being configured to create and store digital audio files of the over the air radio broadcasts to a searchable and sortable database.

2. The audio broadcast recording device of claim 1, where said plurality of function buttons include some or all of: a record button to record audio broadcasts; a play button to play stored digital audio files; a fast forward button to fast forward through digital audio files; a pause button to pause playback of audio files or audio broadcasts; a rewind button to rewind back through digital audio files; and a live radio button to play live over the air radio broadcasts.

3. The audio broadcast recording device of claim 1, wherein said visual display is a touchscreen display; said touchscreen display being capable of processing physical selections by pressing or sliding on the screen.

4. The audio broadcast recording device of claim 1, further comprising a user interface; said user interface being displayed on the visual display; said user interface being configured to transfer digital audio files to and from the audio broadcast recording device to other devices; said user interface being configured to search and sort the database of stored digital audio files; said user interface being configured to search the internet for images and information related to the digital audio files.

5. The audio broadcast recording device of claim 2, further comprising a user interface; said user interface being displayed on the visual display; said user interface being configured to transfer digital audio files to and from the audio broadcast recording device to other devices; said user interface being configured to search and sort the database of stored digital audio files; said user interface being configured to search the internet for images and information related to the digital audio files.

6. The audio broadcast recording device of claim 3, further comprising a user interface; said user interface being displayed on the visual display; said user interface being configured to transfer digital audio files to and from the audio broadcast recording device to other devices; said user interface being configured to search and sort the database of stored digital audio files; said user interface being configured to search the internet for images and information related to the digital audio files.

7. The audio broadcast recording device of claim 1, further comprising a detachable power cord; said detachable power cord being plugged into one of said universal serial bus ports and providing power to said audio broadcast recording device.

8. The audio broadcast recording device of claim 1, wherein said rear surface contains a folding stand; said folding stand collapsing within the rear surface in a stored position and extending outwardly from the rear surface in an open position.

9. The audio broadcast recording device of claim 1, wherein said rear surface contains a folding stand; said folding stand collapsing within the rear surface in a stored position and extending outwardly from the rear surface in an open position.

10. The audio broadcast recording device of claim 2, wherein said rear surface contains a folding stand; said folding stand collapsing within the rear surface in a stored position and extending outwardly from the rear surface in an open position.

11. The audio broadcast recording device of claim 3, wherein said rear surface contains a folding stand; said folding stand collapsing within the rear surface in a stored position and extending outwardly from the rear surface in an open position.

12. The audio broadcast recording device of claim 4, wherein said rear surface contains a folding stand; said folding stand collapsing within the rear surface in a stored position and extending outwardly from the rear surface in an open position.

13. The audio broadcast recording device of claim 5, wherein said rear surface contains a folding stand; said folding stand collapsing within the rear surface in a stored position and extending outwardly from the rear surface in an open position.

14. The audio broadcast recording device of claim 6, wherein said rear surface contains a folding stand; said folding stand collapsing within the rear surface in a stored position and extending outwardly from the rear surface in an open position.

15. The audio broadcast recording device of claim 7, wherein said rear surface contains a folding stand; said folding stand collapsing within the rear surface in a stored position and extending outwardly from the rear surface in an open position.

16. The audio broadcast recording device of claim 8, wherein said rear surface contains a folding stand; said folding stand collapsing within the rear surface in a stored position and extending outwardly from the rear surface in an open position.
